(19) United States
(12) Patent Application Publication
(10) Pub. No.: US 2010/0050127 A1
(43) Pub. Date: Feb. 25, 2010

(54) SYSTEM AND METHOD FOR SIMPLIFYING OPERATIONS OF AN ELECTRONIC DEVICE

(75) Inventor: CHAO-YUN PENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/491,258

(22) Filed: Jun. 25, 2009

(30) Foreign Application Priority Data
Aug. 19, 2008 (CN) 200810304032.5

(51) Int. Cl. G06F 3/048

(52) U.S. Cl. 715/841

(57) ABSTRACT

A system and method for simplifying operations of an electronic device sets a first duration that a cursor is allowed to stay on each root menu option which has sub-menu options, and sets a second duration that the cursor is allowed to stay on each leaf menu option which has no sub-menu options. If the cursor stays on a root menu option beyond the first duration, the system and method controls the electronic device automatically to enter a lower hierarchy menu interface corresponding to the root menu option. If the cursor stays on a leaf menu option beyond the second duration, the system and method controls the electronic device to directly return to a main menu interface from the leaf menu option.

### BACKGROUND

1. Technical Field

Embodiments of the present disclosure are related to systems and methods for operating electronic devices, and particularly to a system and method for simplifying operations of an electronic device.

2. Description of Related Art

At present, electronic devices, such as mobile phones, personal digital assistants, etc., provide more and more functions. Often, menu options corresponding to the functions are organized into a plurality of hierarchies. On a main menu interface of an electronic device, only main menu options are displayed. When a user wants to operate a desired menu option, the user often needs to select a main menu option displayed on the main menu interface first, then search for the desired menu option in sub-menu options of a sub-menu interface corresponding to the main menu option. If the desired menu option does not exist in the sub-menu interface, the user may need to enter a further sub-menu interface of a sub-menu option, until the desired menu option occurs. Moreover, if the user wants to return the main menu interface from any sub-menu interface, the user may need to press a “BACK” key repeatedly until returning to the main menu interface, or end the current sub-menu interface directly by pressing a hang-off key of the electronic device, and reenter the main menu interface. The above mentioned operation method is repetitive and time-consuming.

### BRIEF DESCRIPTION OF THE DRAWINGS

FIG. 1 is a block diagram of one embodiment of an electronic device comprising a system for simplifying operations of the electronic device.

FIG. 2A and FIG. 2B is a flowchart of one embodiment of a method for simplifying operations of the electronic device in FIG. 1.

FIG. 3 illustrates menu options organized in different hierarchies in the electronic device.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

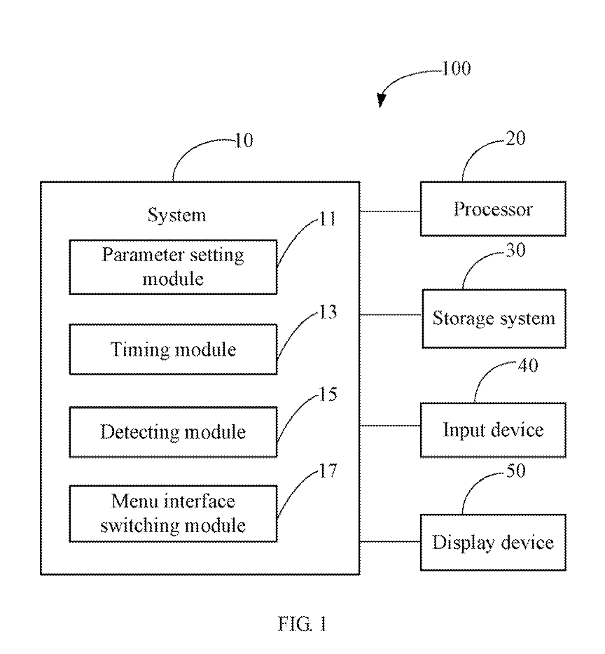

FIG. 1 is a block diagram of one embodiment of an electronic device 100 comprising a system 10 for simplifying operations of the electronic device 100. The electronic device 100 may include at least one processor 20, a storage system 30, an input device 40, and a display device 50. The at least one processor 20 executes computerized codes for the system 10, to simplify operations of the electronic device 100. In one embodiment, the system 10 is included in the storage device 30 or a computer readable medium of the electronic device 100. Depending on the embodiment, the electronic device 100 may be a mobile phone or a personal digital assistant. In another embodiment, the system 10 may be included in an operating system of the electronic device 100.

The storage system 30 may be a smart media card, a secure digital card, a compact flash card, a multimedia card, or an extreme digital card, for example. The input device 40 may include a keyboard and a touch screen, for users to operate the electronic device 100, such as to browse menu options of a user interface of the electronic device 100, select any menu option and use a function provided by the menu option, for example. The display device 50 displays the menu options.

In one embodiment, the system 10 includes a parameter setting module 11, a timing module 13, a detecting module 15, and a menu interface switching module 17. Each of the modules 11-17 may comprise one or more computerized operations to be executed by the at least one processor 20 of the electronic device 100.

The parameter setting module 11 is operable to set a first allowable duration and a second allowable duration that a cursor is allowed to stay on any menu option of the user interface of the electronic device 100. For example, the first allowable duration may be set as 3 seconds, and the second allowable duration may be set as 5 seconds. The cursor may be shown as an arrow icon or a little palm icon on the display device 50, for example.

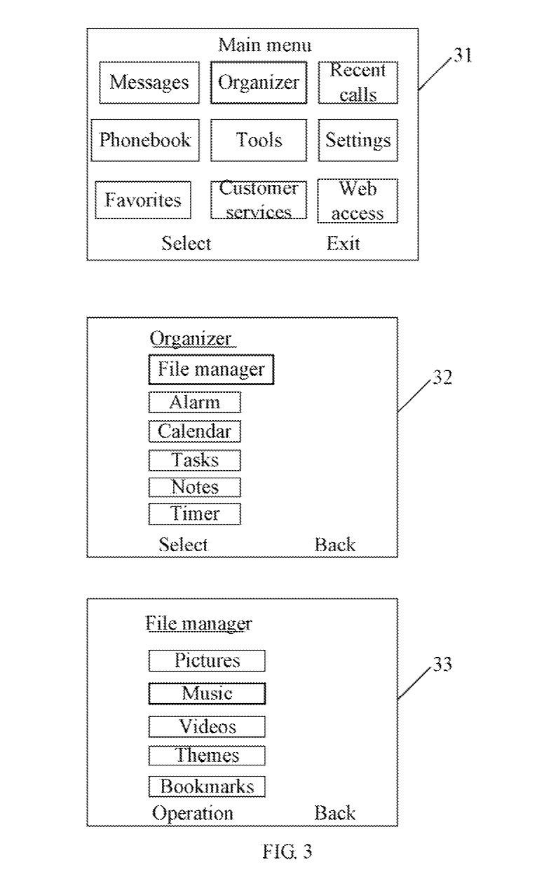

The timing module 13 is operable to time how long does the cursor stays on a menu option. For example, as shown in FIG. 3, a main menu interface 31 of the electronic device 100 displays a plurality of menu options on the display device 50, such as “Messages,” “Organizer,” “Recent calls,” and so on. If the cursor stays on the menu option “Messages,” the timing module 13 starts timing from zero. If the cursor moves to the menu option “Organizer” from the menu option “Messages,” in response that a user presses a navigation key rightwards, the timing module 13 restarts timing from zero. The navigation key on the keyboard of the mobile electronic device 100 may have four-direction functions, such as upwards, downwards, leftwards, and rightwards functions that can respectively make the cursor move upwards, downwards, leftwards, and rightwards on the display device 50.

The detecting module 15 is operable to detect if the cursor stays on a root menu option which has sub-menu options beyond the first allowable duration, and to detect if the cursor stays on a leaf menu option which has no sub-menu options beyond the second allowable duration. For example, as shown in a sub-menu interface 32 in FIG. 3, the menu option “Organizer,” which has a plurality of sub-menu options (such as “File manager,” “Alarm,” “Calendar,” etc.) is regarded as a root menu option. The sub-menu option “File manager,” which has further sub-menu options (such as “Pictures,” “Music,” “Videos,” etc.), as shown in a further sub-menu interface 33 in FIG. 3, is also regarded as a root menu option. The sub-menu option “Music,” which has no further sub-menu options is regarded as a leaf menu option. Then, if the cursor stays on the menu option “Organizer” or the sub-menu option “File manager,” the detecting module 15 detects if stay time of the cursor is beyond the first allowable duration, such as 3 seconds. If the cursor stays on the sub-menu option “Music,” the detecting module 15 detects if stay time of the cursor is beyond the second allowable duration, such as 5 seconds.

The menu interface switching module 17 is operable to automatically switch the electronic device 100 to a sub-menu interface of the root menu option, if the cursor stays on the root menu option beyond the first allowable duration, and to automatically switch the electronic device 100 to the main menu interface, if the cursor stays on the leaf menu option beyond the second allowable duration. For example, if the cursor stays on the menu option “Organizer” of the main menu interface 31 beyond 3 seconds, the menu interface switching module 17 automatically switches the electronic device 100 to the sub-menu interface 32 of the menu option “Organizer.” Furthermore, if the cursor stays on the sub-menu option “File manager” of the sub-menu interface 32 beyond 3 seconds, the menu interface switching module 17 automatically switches the electronic device 100 to the sub-menu interface 33 of the sub-menu option “File manager.” If the cursor stays on the sub-menu option “Music” of the sub-menu interface 33 beyond 5 seconds, the menu interface switching module 17 automatically switches the electronic device 100 to the main menu interface 31.

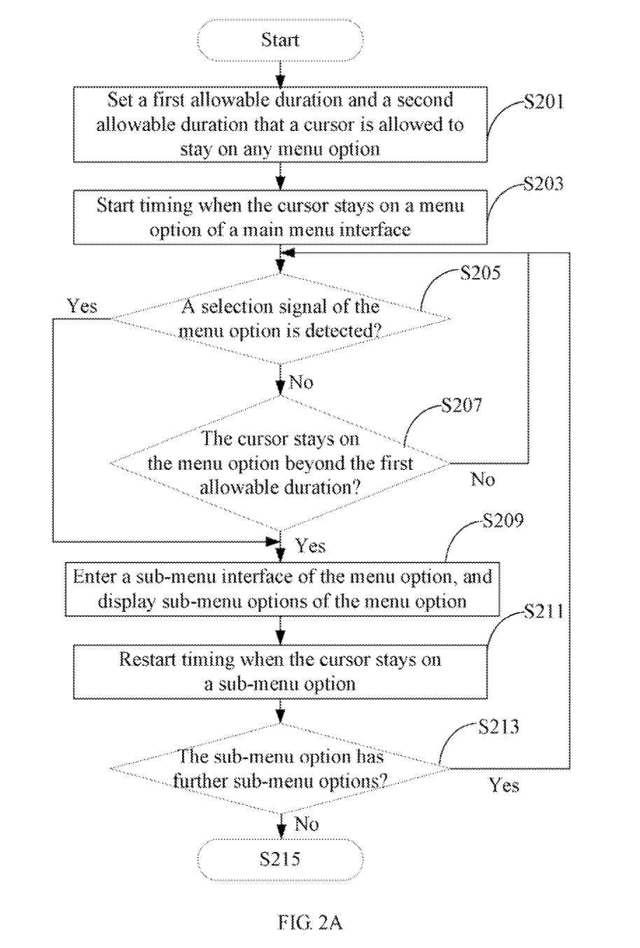

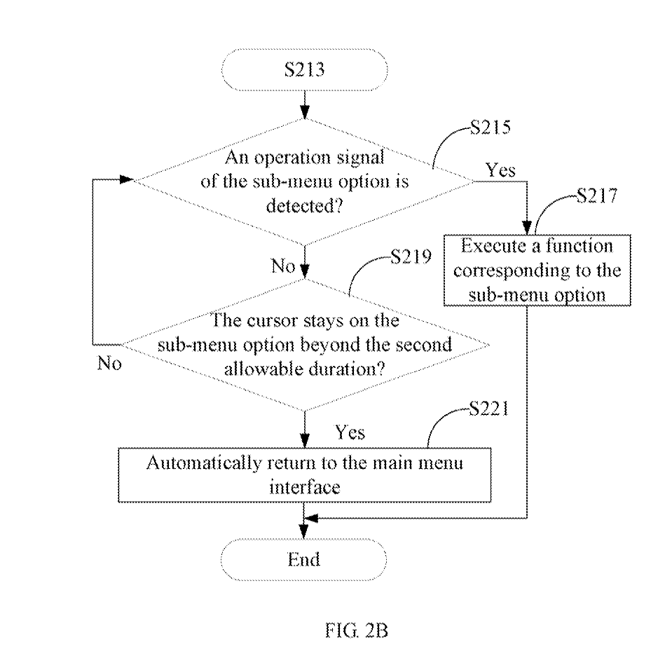

FIG. 2A and FIG. 2B is a flowchart of one embodiment of a method for simplifying operations of the electronic device 100 in FIG. 1. Depending on the embodiment, additional blocks may be added, others removed, and the ordering of the blocks may be changed.

In block S201, the parameter setting module 11 sets a first allowable duration and a second allowable duration that a cursor is allowed to stay on any menu option of a user interface displayed on the display device 50 of the electronic device 100. As mentioned above, the parameter setting module 11 sets the first allowable duration as 3 seconds, and sets the second allowable duration as 5 seconds.

In block S203, the timing module 13 times how long does the cursor stays on a menu option on a main menu interface. For example, as shown in FIG. 3, when the cursor stays on a menu option “Organizer” of a main menu interface 31, the timing module 13 starts timing from zero.

In block S205, the detecting module 15 detects a selection signal of the menu option from the input device 40. The selection signal corresponds to a computerized command of the input device 40 to show sub-menu options of the menu option. If a selection signal of the menu option is detected from the input device 40, the procedure goes to block S209 describe below. Otherwise, if no selection signal of the menu option is detected from the input device 40, the procedure goes to block S207 describe below.

In block S207, the detecting module 15 detects if the cursor stays on the menu option beyond the first allowable duration. For example, the detecting module 15 detects if the cursor stays on the menu option “Organizer” of the main menu interface 31 beyond 3 seconds. If the cursor stays on the menu option within the first allowable duration, the procedure returns to block S205 describe above. Otherwise, if the cursor stays on the menu option beyond the first allowable duration, the procedure goes to block S209.

In block S209, the menu interface switching module 17 switches the electronic device 100 to enter a sub-menu interface of the menu option, and to display the sub-menu options of the menu option on the sub-menu interface. For example, the menu interface switching module 17 switches the electronic device 100 to enter a sub-menu interface 32 of the menu option “Organizer” (as shown in FIG. 3).

In block S210, the timing module 13 restarts timing when the cursor stays on a sub-menu option on the sub-menu interface. For example, when the cursor stays on a sub-menu option “File manager” on the sub-menu interface 32 (as shown in FIG. 3), the timing module 13 restarts timing from zero.

In block S213, the detecting module 15 detects if the sub-menu option has further sub-menu options. If the sub-menu option has further sub-menu options, the procedure repeats from block S205 with regard to the sub-menu option. If the sub-menu option does not have further sub-menu options, the procedure goes to block S215 described below. For example, the sub-menu option “File manager” has further sub-menu options, then the procedure repeats from block S205 with regard to the sub-menu option “File manager,” until the cursor stays on a further sub-menu option which has no further sub-menu options, such as the sub-menu option “Music” on a sub-menu interface 33 of the sub-menu option “File manager,” then the procedure goes to block S215.

In block S215, the detecting module 15 detects an operation signal of the sub-menu option from the input device 40. The operation signal corresponds to an computerized command of the input device 40 to execute a corresponding option of the sub-menu option. If an operation signal of the sub-menu option is detected from the input device 40, in block S217, the electronic device 100 executes a function corresponding to the sub-menu option. For example, if the cursor stays on the sub-menu option “Music” on the sub-menu interface 33, a playing music operation signal may be detected from the input device 40, then the electronic device 100 plays music.

Otherwise, in block 215, if no operation signal of the sub-menu option is detected from the input device 40, the procedure goes to block S219.

In block S219, the detecting module 15 detects if the cursor stays on the sub-menu option beyond the second allowable duration. For example, the detecting module 15 detects if the cursor stays on the sub-menu option “Music” beyond 5 seconds. If the cursor stays on the sub-menu option within the second allowable duration, the procedure returns to block S215 described above. Otherwise, if the cursor stays on the sub-menu option beyond the second allowable duration, the procedure goes to block S221.

In block S221, the menu interface switching module 17 automatically switches the electronic device 100 to the main menu interface. For example, as shown in FIG. 3, if the cursor stays on the sub-menu option “Music” beyond 5 seconds, the menu interface switching module 17 automatically switches the electronic device 100 to the main menu interface 31 from the sub-menu interface 33.

The above embodiments set thresholds for stay time of the cursor, if the cursor stays on a menu option exceeds one of the thresholds, the electronic device 100 will automatically go to a lower hierarchy menu interface corresponding to the menu option, or directly returns to the main menu interface, which depending on whether the menu option has sub-menu options. Therefore, the user of the electronic device 100 does not need to repeatedly press a “SELECT” key for searching for a desired menu option, and does not need to repeatedly press a “BACK” key to return to the main menu interface from the desired menu option.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A method for simplifying operations of an electronic device, the method comprising:
setting a first allowable duration and a second allowable duration that a cursor is allowed to stay on a menu option of a user interface displayed on a display of the electronic device;
timing how long does the cursor stay on the menu option of a main menu interface of the user interface displayed on the display of the electronic device;
detecting a selection signal of the menu option from an input device of the electronic device;
determining if the cursor stays on the menu option beyond the first allowable duration, in response to not detecting the selection signal of the menu option;
automatically entering a sub-menu interface of the menu option and displaying sub-menu options of the menu option on the display of the electronic device, in response to a determination that the cursor stays on the menu option beyond the first allowable duration;
restarting timing when the cursor stays on a sub-menu option of the sub-menu interface;
detecting an operation signal of the sub-menu option from the input device of the electronic device in response to a determination that the sub-menu option has no further sub-menu options, wherein the operation signal corresponds to a computerized command of the input device to execute a corresponding option of the sub-menu option;
determining if the cursor stays on the sub-menu option beyond the second allowable duration, in response to not detecting the operation signal of the sub-menu option; and
automatically switching to the main menu interface, in response to a determination that the cursor stays on the sub-menu option beyond the second allowable duration.

2. The method as claimed in claim 1, further comprising:
directly entering the sub-menu interface of the menu option, in response to detecting the selection signal of the menu option from the input device of the electronic device; and
returning to the restarting block.

3. The method as claimed in claim 1, further comprising:
returning to the detecting block for detecting the selection signal, in response to a determination that the cursor stays on the menu option within the first allowable duration.

4. The method as claimed in claim 1, further comprising:
returning to the detecting block for detecting the selection signal, if the sub-menu option has further sub-menu options.

5. The method as claimed in claim 1, further comprising:
executing a function corresponding to the sub-menu function, in response to detecting the operation signal of the sub-menu option from the input device of the electronic device.

6. The method as claimed in claim 1, further comprising:
returning to the detecting block for detecting the operation signal, in response to a determination that the cursor stays on the menu option within the second allowable duration.

7. The method as claimed in claim 1, wherein the electronic device is selected from the group consisting of a mobile phone, a personal digital assistant, and a computer.

8. The method as claimed in claim 1, wherein the input device is a touch panel or a keyboard.

9. A system for simplifying operations of an electronic device, the system comprising:
a memory system;
at least one processor; and
one or more programs stored in the memory system and being executed by the at least one processor, the one or more programs comprising:
a parameter setting module to set a first allowable duration and a second allowable duration that a cursor is allowed to stay on a menu option of a user interface of the electronic device;
a timing module to time how long does the cursor stay on the menu option of the user interface of the electronic device;
a detecting module to detect if the cursor stays on a root menu option which has sub-menu options beyond the first allowable duration, and to detect if the cursor stays on a leaf menu option which has no sub-menu options beyond the second allowable duration; and
an interface switching module to automatically switch the electronic device to a sub-menu interface of the root menu option if the cursor stays on the root menu option beyond the first allowable duration, and to automatically switch the electronic device to a main menu interface if the cursor stays on the leaf menu option beyond the second allowable duration.

10. The system as claimed in claim 9, further comprising a display device to display the main menu interface, the sub-menu interface, and menu options under the main menu interface or the sub-menu interface.

11. The system as claimed in claim 9, wherein the electronic device is selected from the group consisting of a mobile phone, a personal digital assistant, and a computer.

12. A storage medium storing a set of instructions, the set of instructions capable of being executed by a processor to perform a method for simplifying operations of an electronic device, the method comprising:
setting a first allowable duration and a second allowable duration that a cursor is allowed to stay on a menu option of a user interface displayed on a display of the electronic device;
timing how long does the cursor stay on the menu option of a main menu interface of the user interface displayed on the display of the electronic device;
detecting a selection signal of the menu option from an input device of the electronic device;
determining if the cursor stays on the menu option beyond the first allowable duration, in response to not detecting the selection signal of the menu option;
automatically entering a sub-menu interface of the menu option and displaying sub-menu options of the menu option on the display of the electronic device, in response to a determination that the cursor stays on the menu option beyond the first allowable duration;
restarting timing when the cursor stays on a sub-menu option of the sub-menu interface;
detecting an operation signal of the sub-menu option from the input device of the electronic device in response to a determination that the sub-menu option has no further sub-menu options, wherein the operation signal corresponds to a computerized command of the input device to execute a corresponding option of the sub-menu option;
determining if the cursor stays on the sub-menu option beyond the second allowable duration, in response to detecting the operation signal of the sub-menu option from the input device of the electronic device; and
automatically switching to the main menu interface, in response to a determination that the cursor stays on the sub-menu option beyond the second allowable duration.

13. The storage medium as claimed in claim 12, wherein the method further comprises:
directly entering the sub-menu interface of the menu option, in response to detecting the selection signal of the menu option from the input device of the electronic device; and
returning to the restarting block.

14. The storage medium as claimed in claim 12, wherein the method further comprises:
returning to the detecting block for detecting the selection signal, in response to a determination that the cursor stays on the menu option within the first allowable duration.

15. The storage medium as claimed in claim 12, wherein the method further comprises:
returning to the detecting block for detecting the selection signal, if the sub-menu option has further sub-menu options.

16. The storage medium as claimed in claim 12, wherein the method further comprises:
executing a function corresponding to the sub-menu function, in response to detecting the operation signal of the sub-menu option from the input device of the electronic device.

17. The storage medium as claimed in claim 12, wherein the electronic device is selected from the group consisting of a mobile phone, a personal digital assistant, and a computer.

18. The storage medium as claimed in claim 12, wherein the input device is a touch panel or a keyboard.
